(19) United States
(12) Patent Application Publication
(10) Pub. No.: US 2009/0037801 A1
(43) Pub. Date: Feb. 5, 2009

(54) Method and apparatus for automatic user manual generation

(75) Inventors: Sheng Ye, Beijing (CN); Hai chuan Wang, Beijing (CN); Guan Qun Zhang, Beijing (CN); He Yuan Huang, Beijing (CN)

Correspondence Address: RYAN, MASON & LEWIS, LLP, 90 FOREST AVENUE, LOCUST VALLEY, NY, 11560, US

(73) Assignee: International Business Machines Corporation, Armonk, NY (US)

(21) Appl. No.: 11/441,380

(22) Filed: May 25, 2006

(30) Foreign Application Priority Data
May 26, 2005 (CN) 200510073030.6

(51) Int. Cl. G06F 17/00

(52) U.S. Cl. 715/202

(57) ABSTRACT

The present invention discloses a method of generating a document, the method including the steps of: recording information of operating an information technology system; putting the information into a document model; and generating the document by mapping the information in the document model. The present invention further discloses a system of generating a document. According to the present invention, the producer of user manual needs to operate an IT system once only, then the user manual of the IT system will be automatically generated. Thus, the producer of the user manual does not have to do repetitive and tedious work any longer, and a large amount of producing time is saved accordingly. Moreover, the style of the user manual can be defined by the producer. According to the present invention, user manuals in different language versions can be easily generated. The generated user manual has a standard format.

### CROSS-REFERENCE TO RELATED APPLICATION(S)

This application is based on the Chinese Patent Application No. 200510073030.6 filed on may 27, 2005, the disclosure of which is hereby incorporated by reference thereto in its entirety, and the priority of which is hereby claimed under 35 U.S.C. §119.

### FIELD OF THE INVENTION

The present invention relates to information technology field, and more particularly to a method and a system of generating a document.

### BACKGROUND OF THE INVENTION

Currently, as information technology (IT) systems become more and more complex, user manuals of these IT systems also become increasingly complex and even more important to users than ever Normally, a user manual is a document describing the usage of an IT system, and it helps users to understand the functions, interfaces of the IT system, etc. Usually, a user manual introduces the general functions and features of an IT system, and gives step-by-step operation guides to help users master the operations of the IT system.

At present, to produce a user manual of an IT system, a producer must be able to use the IT system skillfully and write down the procedures in operating the IT system. The operating procedures usually include user input and system feedback, such as mouse or keyboard input, and screen and sound output.

Today, there are not only tools to capture screen flows, which can be used as video demo, but also tools to record input operations of a user. However, these tools are far from enough to write a user manual. When producing a user manual, the producer needs to write down his/her operations, copy screens, paste these copied screens into a user manual document, and add some description. For example, a typical user input may be described as typing “xxx” and clicking the button “OK”. It can be seen that the task of creating a user manual contains many repetitive operations.

Therefore, there is a need for a method and a system for generating a document, so that a producer of a user manual does not have to do repetitive and tedious work any longer, and a large amount of producing time is saved accordingly.

### SUMMARY OF THE INVENTION

It is an object of the present invention to provide a method and a system of generating a document, which can reduce the producing time of the document.

To achieve the above-mentioned object, the present invention proposes a method for generating a document, the method including the steps of: recording information of operating an information technology system; putting the information into a document model; and generating the document by mapping the information in the document model.

Preferably, the information includes messages sent in an operating system during operating the information technology system.

Preferably, the information includes screens after and before at least one operation.

Preferably, the information includes the time sequence of operations.

Preferably, the document is generated by mapping the information to the corresponding portions of a document template.

Preferably, the method further includes a step of: accepting modifications to the contents in the document model.

Preferably, the document is a user manual of the information technology system.

The present invention further proposes a system for generating a document, comprising: a recording module, for recording information of operating an information technology system; and a generating module, for generating the document by mapping the information putted into a document model.

According to the present invention, the producer of a user manual needs to operate an IT system once only, and then the user manual of the IT system will be generated automatically, so that the producer of the user manual does not have to do repetitive and tedious work any longer, such as writing down his/her operations, copying screens, pasting these screens into the user manual document and providing some description. Therefore, a large amount of producing time can be saved. Moreover, the style of the user manual can be defined by the producer. According to the present invention, user manuals in different language versions can be generated easily. The generated user manuals have a standard format, and the producer can edit the generated user manual in an existing editor with ease.

Other features, objects and effects of the present invention will become clearer and more comprehensible from the following description of the preferred embodiments of the present invention, taken in conjunction with the accompanying drawings

### BRIEF DESCRIPTION ON THE DRAWINGS

Hereinafter, the preferred embodiments of the present invention will be described with reference to the accompanying drawings in which:

FIG. 1 is a schematic block diagram illustrating a computer system capable of carrying out an embodiment of the present invention;

FIG. 2 is an example of one page of a user manual;

FIG. 3 is a flowchart of generating a user manual according to an embodiment of the present invention;

FIG. 4 is an example of a screen appearing when a producer is operating an IT system;

FIG. 5 is an example of a document model; and

FIG. 6 is a schematic diagram of generating a user manual by mapping contents in a document model to a user manual template according to an embodiment of the present invention.

Throughout the above accompanying drawings, the same numeral denotes the same, like or corresponding features and functions.

### DESCRIPTION OF THE PREFERRED EMBODIMENTS

Here, the preferred embodiments of the present invention are described with automatically generating a user manual of an IT system, such as a user manual of the operation of a computer software, a user manual of the operation of a digital equipment, and the like, taken for example. However, those of ordinary skill in the art shall understand that the present invention is not limited thereto. The present invention is also applicable to generate the document of other types, e.g. a web page.

As used herein, the term “executable code” is intended to include any type of computer instructions and computer executable codes, which may be located within a storage device and/or be transmitted as electric signals over a system bus or a network. An identical module of executable code may, for instance, comprise one or more physical or logical blocks of computer instructions, which may, for instance, be organized as object, procedure, or function. Nevertheless, the executable code of an module comprising different instructions needs not to be physically located together, but may comprise disparate instructions stored in different locations which, when joined logically together, will form the module and achieve the stated object or function of the module. Indeed, an executable code may be a single instruction, or many instructions, and may even be distributed over several different code segments, among different programs, and across several storage devices.

Similarly, operands may be identified within modules, and may be embodied in any suitable form, and organized within any suitable type of data structure.

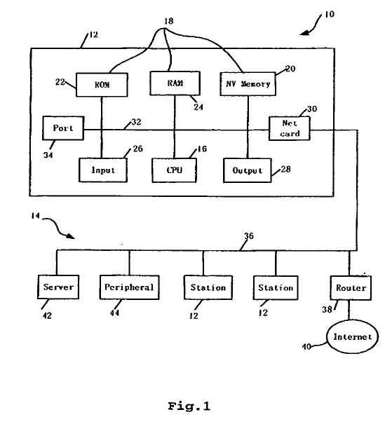

FIG. 1 is a schematic block diagram illustrating a computer system 10, in which modules and operands, operating in accordance with the present invention can be hosted on one or more computer stations 12 in a network 14.

Typically, the computer station 12 can comprise a processor or CPU 16. The CPU 16 can be connected to one or more storage devices 18. The storage device 18 shown in FIG. 1 comprises a non-volatile storage device 20 such as hard disk or optical disk, a read-only memory (ROM) 22, as well as a volatile, random access memory (RAM) 24.

The computer station 12 may further comprise one or more input devices 26, e.g. mouse or keyboard, for receiving inputs from a user or other devices. Similarly, the computer station 12 may further comprise one or more output devices 28, e.g. a display. Also, the computer station 12 may even further comprise a network port 30, such as network interface card and the like, for connecting is to other devices via the network 14. When the computer station 12 is far away from the network 14, the network port 30 may comprise a modem and be connected to the network 14 via a local access line, such as telephone line.

In any one of computer stations 12, there is a system bus 32 capable of interconnecting the CPU 16, the storage device 18, the input device 26, the output device 28, the network port 30 and one or more additional ports 34. The system bus 32 and a network backbone 36 may be thought of as data carriers, and can be embodied in numerous configurations, such as wire, cable, optical cable, visible light wireless communication, infrared light communication and the like.

In general, the network 14 may comprise a single local area network (LAN), a wide area network (WAN) and an intranet and the like. The individual computer stations 12 communicate with each other over the backbone 36 with varying degrees and types of communication capabilities and logic capabilities. The network 14 may further comprise an application server 42 and/or other resource or peripheral 44, such as printer and scanner.

On the network 14, different communication protocols such as ISO/OSI, TPX and TCP/IP may be used. Other networks may communicate with the network 14 over, for example, the Internet 40 and/or through a router 38.

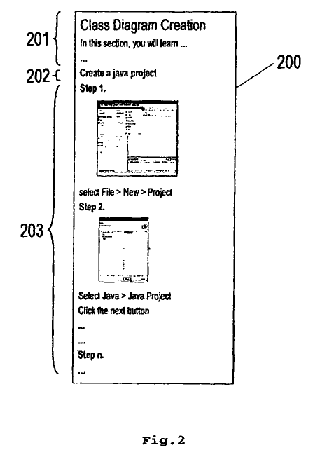

FIG. 2 is an example of one page of a user manual.

As shown in FIG. 2, a user manual 200 includes a describing portion 201. In the describing portion 201, the objective of the page is described in general. For instance, the page of the user manual is directed to help users of an IT system learn how to create class diagram. The user manual may further comprise a task describing portion 202. In the task describing portion 202, the task of the page of the user manual is described, for example, to create a JAVA project. The user manual 200 may even further comprise a step portion 203. In the step portion 203, the steps of the operations needed for creating a task are described according to operating order. Contents reflecting these steps generally include screens and action hints, wherein the screens are the screens of operations by users. For instance, to create a JAVA project, the first step is to select file>new>project in a menu of the displayed screen; the second step is to select Java>Java project in the screen displayed subsequently, and to click the button “next”; and so on.

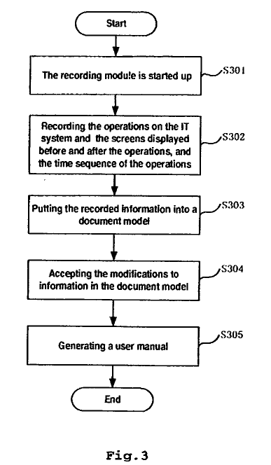

FIG. 3 is a flowchart of generating a user manual according to an embodiment of the present invention.

Hereinafter, the flowchart shown in FIG. 3 is described with reference to the computer system shown in FIG. 1.

Suppose an IT system is loaded in the computer system shown in FIG. 1. When the producer of a user manual of the IT system starts to produce the user manual, he or she can start-up a recording module through the input device 26 (Step 301). The recording module can be located on the storage device 18.

Next, in Step 302, the recording module records the operations of the producer on the IT system and captures the screens displayed before the operations and the screens appeared after the operations. In addition, the recording module records the time sequence of the operations.

Of course, the recording module may further record other information according to needs. The kinds and amount of the information recorded do not form limitations to the present invention.

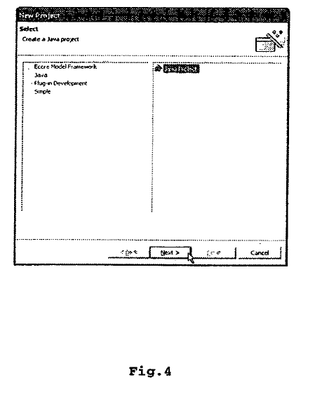

When the producer operates the IT system through operating the input device 26, such as mouse moving or clicking and keyboard striking, some messages will be sent to the operating system. For instance, when the producer is creating a new Java project, a dialogue box guide will be displayed on the output device 28, and the producer performs two steps of operations on the guide through the input device 26. The first step is to click “Java project” in the dialogue box, and the second step is to click the button “next”, as shown in FIG. 4.

When the producer performs the above-mentioned operations, the recording module will get two messages from the operating system. By parsing the two messages, it can be obtained that the action type of the first operation is “select”, the action target thereof being the item “Java project”; and the action type of the second operation is “click”, the action target thereof being the button “next”. In the meantime, the recording module records the time sequence of the two operations, namely flow script, for example, first to select “Java project” and then to click the button “next”.

Afterwards, in Step S303, the above information recorded by the recording module, which includes the operations of the producer, screens before and after the operations, and the time sequence of the operations, are put into a document model, and the document model is displayed on the output device 28 so as to facilitate a next process.

It shall be understood that the document model can be generated either by the recording module or the generating module to be described below.

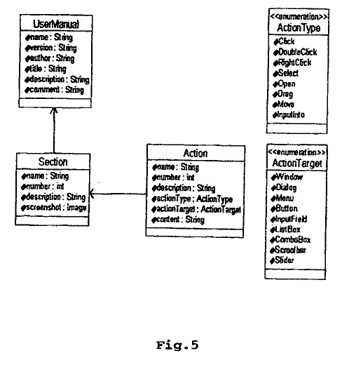

FIG. 5 is an example of a document model. As shown in FIG. 5, the document model includes name, version, author, title, description, comment and soon. The document model may comprise multiple sections (FIG. 5 only shows one section), each section includes name, description, screen and so on. Besides, each section may further comprise several actions (FIG. 5 only shows one action), wherein the action includes action type, action target and so on. The action type includes click, double click, right click, select, open, drag, move, input information and so on. The action target includes window, dialogue box, menu, button, input field, list box, combo box, scroll bar, slider and so on.

Next, In Step S304, modifications to information in the document model are accepted.

Perhaps contents in the above document model are not good enough to generate a user manual with excellent readability. Thus, the producer has to modify contents in the document model through the input device 26, for example, add relevant description, add name and title, modify action type and action target, and modify other information and the like.

Then, in Step S305, a user manual is generated.

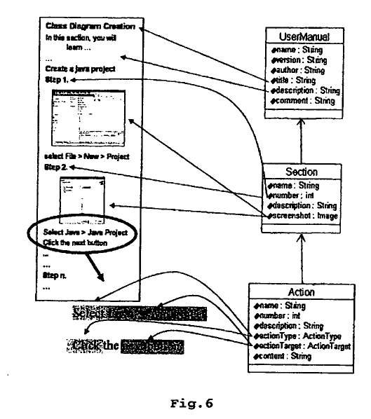

When the producer finishes modifications, a generating module, which may be located on the memory device 18, generates a user manual corresponding to the above operations by mapping the modified document model to a user manual template. For instance, as shown in FIG. 6, the title in the document model is mapped to the describing portion of the user manual template, the screens in the section, the action types and targets of all the actions and the like are mapped to the step portion.

By mapping the modified document model to different user manual templates, user manuals in different styles and languages can be generated, such as bookmark format-based English user manual or webpage format-based Chinese user manual.

The user manual generated as such comprises the main frame of a user manual. Moreover, the producer can edit the generated user manual in an existing editor so as to finalize a better version of the user manual.

It shall be understood that, those skilled in the art can achieve the above recording module and generating module by various methods, such as Java language-based codes.

Of course, those skilled in the art shall also appreciate that the system of generating a document which comprises the above recording module and generating module may be located on the storage device 18 or be transmitted as electrical signal over a system bus or a network.

Various changes and alternations can be made without departing from the concept and scope of the present invention. It shall be understood that the present invention is not limited to the specific embodiments, and the scope thereof is defined by the claims as appended.

What is claimed is:

1. A method for generating a document, including the steps of:
(a) recording information of operating an information technology system;
(b) putting the information into a document model; and
(c) generating the document by mapping the information in the document model.

2. The method as claimed in claim 1, wherein the information includes messages sent in an operating system during operating the information technology system.

3. The method as claimed in claim 1, wherein the information includes screens after and before at least one operation.

4. The method as claimed in claim 1, wherein the information includes the time sequence of operations.

5. The method as claimed in claim 1, wherein in step (c), the document is generated by mapping the information in the document model to the corresponding portions of a document template.

6. The method as claimed in claim 1, between step (b) and step (c) further including the step of:
accepting modifications to the information in the document model.

7. The method as claimed in any one of claims 1-6, wherein the document is a user manual of the information technology system.

8. A system for generating a document, comprising:
a recording module for recording information of operating an information technology system; and
a generating module for generating the document by mapping the information putted into a document model.

9. The system as claimed in claim 8, wherein the information includes messages sent in an operating system during operating the information technology system.

10. The system as claimed in claim 8, wherein the information includes screens after and before at least one operation.

11. The system as claimed in claim 8, wherein the information includes the time sequence of operations.

12. The system as claimed in claim 8, wherein the document model is generated by the recording module.

13. The system as claimed in claim 8, wherein the document model is generated by the generating module.

14. The system as claimed in claim 8, wherein the generating module generates the document by mapping the information in the document model to the corresponding to portions of a document template.

15. The system as claimed in claim 8, wherein the information in the document model is modified in accordance with needs.

16. The system as claimed in any one of claims 8-15, wherein the document is a user manual of the information technology system.

17. A computer program comprising instructions executable by a computer for performing the steps in any one of methods as claimed in claims 1-7
